(19) United States
(12) Patent Application Publication
(10) Pub. No.: US 2026/0085565 A1
(43) Pub. Date: Mar. 26, 2026

(54) AN ELECTRICALLY DRIVEN CONTROL SYSTEM FOR A ROTATABLE UPRIGHT BLAST DOOR

(71) Applicants: GUANGZHOU METRO DESIGN & RESEARCH INSTITUTE CO., LTD., Guangzhou (CN); HUNAN YUNHUI TECHNOLOGY CO., LTD., Changsha (CN)

(72) Inventors: Tao TAO, Guangzhou (CN); Yangming WANG, Guangzhou (CN); Luoping LI, Guangzhou (CN); Ziping ZHOU, Guangzhou (CN); Kunyang XIAO, Guangzhou (CN); Jun TANG, Guangzhou (CN); Guizhi ZHANG, Guangzhou (CN); Chengliang ZENG, Guangzhou (CN); Yanming JIA, Guangzhou (CN); Kaiyu WANG, Guangzhou (CN); Hao GUO, Guangzhou (CN); Qixuan CHANG, Guangzhou (CN); Shou LIU, Guangzhou (CN); Wei ZHANG, Guangzhou (CN); Junlong ZHAO, Guangzhou (CN); Dongzhu ZHENG, Guangzhou (CN); Xiaochun DAI, Guangzhou (CN); Chao CHEN, Guangzhou (CN); Xiaojiao MA, Guangzhou (CN); Weimin QIN, Guangzhou (CN)

(21) Appl. No.: 19/108,114

(22) PCT Filed: Jan. 2, 2025
(86) PCT No.: PCT/CN2025/070203

§ 371 Date: Feb. 28, 2025

(30) Foreign Application Priority Data
Sep. 25, 2024 (CN) 202411337290.9

(51) Int. Cl. E05F 15/616

(52) U.S. Cl. CPC E05F 15/616

(57) ABSTRACT

An electrically driven control system for a rotatable upright blast door comprises: a blast door including a door body; an opening and closing device of electric cylinder of rotatable upright door body including a drive motor module and a push rod coupled to a power output end of the drive motor module, and the opening and closing device of electric cylinder of rotatable upright door body is hinged relative to the mounting base, and the push rod is hinged to the door body. In the present invention, the opening and closing of the door body is driven by an electric cylinder structure, which has a small layout space and a large opening and closing torque. An opening and closing device of electric cylinder of rotatable upright door body has a simple structure, which reduces the complexity of maintenance and management. Compared with the hydraulic drive system, the opening and closing device of electric cylinder of rotatable upright door body does not need to regularly replace the hydraulic oil, to clean oil circuits and to repair hydraulic components, which reduces maintenance costs and workload, and also is a solution that meets environmental protection and modern management. After the present invention is used in the practical application, it can solve the problems of inconvenient maintenance and poor safety of the operation in the prior art of blast doors adopting a hydraulic drive system.

### TECHNICAL FIELD

The present invention relates to the technical field related to protective equipment, and more specifically, in particular, it relates to an electrically driven control system for a rotatable upright blast door.

### BACKGROUND

In prior art, a typical hydraulic drive system possesses a structure that: a hydraulic oil station is included, and the hydraulic oil (L-HM46 type, anti-wear) is utilized as a hydraulic conductor; a three-phase asynchronous motor drives a hydraulic oil pump to deliver pressure (up to 20 MPa), which enters the chamber with rods (or the oil chamber without rods) of the hydraulic oil cylinder through a high-pressure oil pipe, and uses the pressure difference at both ends of the oil cylinder to push the piston to move; one end of the push rod is connected to the blast door body, and the other end is connected to a bracket on the wall on one side of the blast door frame in the tunnel, thereby pushing the blast door to open or close.

Due to a large number of hydraulic valves, pipelines and joints provided between the hydraulic drive system and the blast door, and the humid environment in the subway tunnel, it is difficult to do the daily maintenance. A missing detection or error detection will easily cause oil leakage in the hydraulic drive system, such that it is hard to keep the operation of subway in a good maintenance, leaving a potential risk for the operation of subway. In addition, the leakage of hydraulic oil will also cause environmental pollution.

### SUMMARY

### (I) Technical Problems

In summary, how to solve the problems of inconvenient maintenance and the poor safety of the operation of the blast door using a hydraulic drive system in the existing subway project has become a problem that needs to be urgently solved by those skilled in the art.

### (II) Technical Solutions

In order to achieve the above-mentioned purpose, the present invention provides the following technical solutions:

The present invention provides an electrically driven control system for a rotatable upright blast door. In the present invention, the electrically driven control system for a rotatable upright blast door includes:
a blast door for mounting onto a mounting base, the blast door comprising a door body which is rotatable, upright, and is a side hung door;
an opening and closing device of electric cylinder of rotatable upright door body for implementing an electrical opening and closing of the door body, the opening and closing device of electric cylinder of rotatable upright door body including a drive motor module and a push rod coupled to a power output end of the drive motor module; the opening and closing device of electric cylinder of rotatable upright door body being hinged relative to the mounting base and the push rod being hinged to the door body;
a blast door control system for implementing an operation of the electrically driven control system, wherein, the blast door control system is a redundant control system, and the blast door control system includes a main controller and a backup controller, and both the main controller and the backup controller can independently control the operation of the electrically driven control system, and when the main controller fails, the backup controller intervenes the operation.

Preferably, in the electrically driven control system for a rotatable upright blast door provided by the present invention, the opening and closing device of electric cylinder of rotatable upright door body includes a door body mounting base for fixing onto the door body, an opening and closing cylinder, the push rod movably mounted on the opening and closing cylinder, a door body opening and closing servo motor for providing power which is provided on the opening and closing cylinder, a first manual rocker which is integrated on the opening and closing servo motor of the door body and is able to manually drive its motor output shaft to rotate, a first reducer connected to a power output end of the door body opening and closing servo motor for decelerating, and a fixed base which is fixed relative to the mounting base; the door body opening and closing servo motor and the first manual rocker are integrated as a whole and compose the drive motor module; the door body opening and closing servo motor includes the motor output shaft, on which a manual rocker gear is arranged for rotating synchronously, and the first manual rocker is intermeshed (meshing connected) with the manual rocker gear through a gear set for manually driving the manual rocker gear to rotate.

Preferably, in the electrically driven control system for a rotatable upright blast door provided by the present invention, push rod teeth are provided on the push rod, the push rod teeth are arranged in a straight line along axis of the push rod, and the push rod is slidably provided in the opening and closing cylinder, and one end of the push rod is positioned within the opening and closing cylinder, and the other end of the push rod is positioned outside the opening and closing cylinder, and a power output end of the first reducer is provided with a driving gear, and the driving gear is meshed with the push rod teeth.

Preferably, in the electrically driven control system for a rotatable upright blast door provided by the present invention, the door body mounting base is a metal member, and the door body mounting base is a unitary structure, and the door body mounting base is fixedly arranged on the door body; the fixed base is a metal member, and the metal member is a unitary structure, and the metal member is fixedly arranged on a door frame of the blast door or is fixedly arranged on the mounting base; one end of the opening and closing cylinder is hinged to the fixed base through a rotating pin, and one end of the push rod is hinged to the door body mounting base through a rotating pin.

Preferably, in the electrically driven control system for a rotatable upright blast door provided by the present invention, there are a plurality of groups of the opening and closing device of electric cylinder of rotatable upright door body, and all opening and closing devices of electric cylinder of rotatable upright door body are arranged at intervals in the height direction.

Preferably, in the electrically driven control system for a rotatable upright blast door provided by the present invention, a manual-electric locking device for the door body is provided on the door body; the manual-electric locking device for the door body includes a locking servo motor and a drive train for the handwheel and the connecting rod, and the drive train for the handwheel and the connecting rod is provided on the door body, and a lock tongue is provided at a movable end of the drive train for the handwheel and the connecting rod, and the drive train for the handwheel and the connecting rod includes a handwheel, with which the locking servo motor can be coupled, for providing electric power or manual work to the drive train for the handwheel and the connecting rod.

Preferably, in the electrically driven control system for a rotatable upright blast door provided by the present invention, the manual-electric locking device for the door body is mounted on front of the door body; and the manual-electric locking device for the door body includes the handwheel, a gear transmission pair, the locking servo motor, a guide rod mounting seat, a guide rod, a connecting rod bracket, a connecting rod, a second reducer and the lock tongue, and the handwheel is connected to an input end of the second reducer; a driven gear of the gear transmission pair is fixed on the handwheel; a driving gear of the gear transmission pair is fixed on an output shaft of the locking servo motor; the guide rod is fixedly connected to the output shaft of the second reducer; the guide rod is slideable in the guide rod mounting seat; the connecting rod bracket is connected to the guide rod; the connecting rod is linked to the guide rod through the connecting rod bracket; and the lock tongue is provided at end of the connecting rod.

Preferably, in the electrically driven control system for a rotatable upright blast door provided by the present invention, a door body guide and servo motor driven locking device is further included, which is used for restricting and locking the opening of the door body when the door body is opened to an extreme position.

Preferably, in the electrically driven control system for a rotatable upright blast door provided by the present invention, the door body guide and servo motor driven locking device includes: a second manual rocker, a lifter, a restriction servo motor, a lifter mounting base, a restriction rod and a restriction seat; the lifter includes a lifter cylinder, in which a liftable screw rod is provided; a power output end of the restriction servo motor is connected to the liftable screw rod through a third reducer for driving the liftable screw rod to rotate and lift in the lifter cylinder; the second manual rocker is integrated as a whole with the restriction servo motor; the restriction rod is connected to the liftable screw rod; the restriction seat is fixed relative to the ground, and the restriction rod is fitted with the restriction seat by insertion.

Preferably, in the electrically driven control system for a rotatable upright blast door provided by the present invention, the door body opening and closing servo motor, the locking servo motor and the restriction servo motor are all servo motors with brakes; an emergency power supply system is further included, which is connected to each of electrical devices of the electrically driven control system, and is used to provide backup power in the power-off state.

### (III) Beneficial Effects

It can be seen from the above, the present invention provides an electrically driven control system for a rotatable upright blast door. In the present invention, the electrically driven control system comprises: a blast door for mounting onto the mounting base, the blast door comprising a door body which is rotatable, upright, and is a side hung door; an opening and closing device of electric cylinder of rotatable upright door body for implementing the electrical opening and closing of the door body, a blast door control system for implementing an operation of the electrically driven control system, wherein, the blast door control system is a redundant control system, and the blast door control system includes a main controller and a backup controller, and both the main controller and the backup controller can independently control the operation of the electrically driven control system, and when the main controller fails, the backup controller intervenes the operation. and the opening and closing device of electric cylinder of rotatable upright door body including a drive motor module and a push rod coupled to a power output end of the drive motor module, and the opening and closing device of electric cylinder of rotatable upright door body is hinged relative to the mounting base, and the push rod is hinged to the door body;

With the above structural design, the present invention includes at least the following advantages: 1. The opening and closing drive of the door body is driven by the opening and closing device of electric cylinder of rotatable upright door body, which has a small layout space and a large opening and closing torque, and is suitable for the usage and layout requirements of the blast door of the subway civil air defense; The opening and closing device of electric cylinder of rotatable upright door body (or the drive system of the electric cylinder for the blast door) has a simple structure, which reduces the complexity of maintenance and management. Compared with the hydraulic drive system, the opening and closing device of electric cylinder of rotatable upright door body does not need to regularly replace the hydraulic oil, to clean oil circuits and to repair hydraulic components, which reduces maintenance costs and workload, and also is a solution that meets environmental protection and modern management. After the present invention is used in the practical application, it can solve the problems of inconvenient maintenance and poor safety of the operation in the prior art of blast doors adopting a hydraulic drive system.

### BRIEF DESCRIPTION OF THE DRAWINGS

The accompanying drawings provide a further understanding to the present invention and are a part of the specification. The exemplary embodiments of the present invention and their explanations are used to interpret the present invention and should not be construed in an improper limiting sense to the present invention, in which:

FIG. 1 is a schematic structural view of the electrically driven control system for the rotatable upright blast door mounted on the mounting base according to an embodiment of the present invention;

FIG. 2 is a schematic structural view (I) of the electrically driven control system for the rotatable upright blast door according to an embodiment of the present invention;

FIG. 3 is a schematic structural view (II) of the electrically driven control system for the rotatable upright blast door according to an embodiment of the present invention;

FIG. 4 is a schematic structural view (III) of the electrically driven control system for the rotatable upright blast door according to an embodiment of the present invention;

FIG. 5 is a schematic structural top view of the electrically driven control system for the rotatable upright blast door according to an embodiment of the present invention, in which the open state and closed state of the door body are both shown;

FIG. 6 is a schematic partial structural view (I) of the electrically driven control system for the rotatable upright blast door according to an embodiment of the present invention, in which the locking servo motor, handwheel and gear transmission pair are included;

FIG. 7 is a schematic partial structural view (II) of the electrically driven control system for the rotatable upright blast door according to an embodiment of the present invention, in which the lifter, the lifter mounting base, the restriction rod and the screw rod are included;

FIG. 8 is a schematic partial structural view (III) of the electrically driven control system for the rotatable upright blast door according to an embodiment of the present invention, in which the locking servo motor, the handwheel, the gear transmission pair, the guide rod mounting seat, the guide rod and the connecting rod are included;

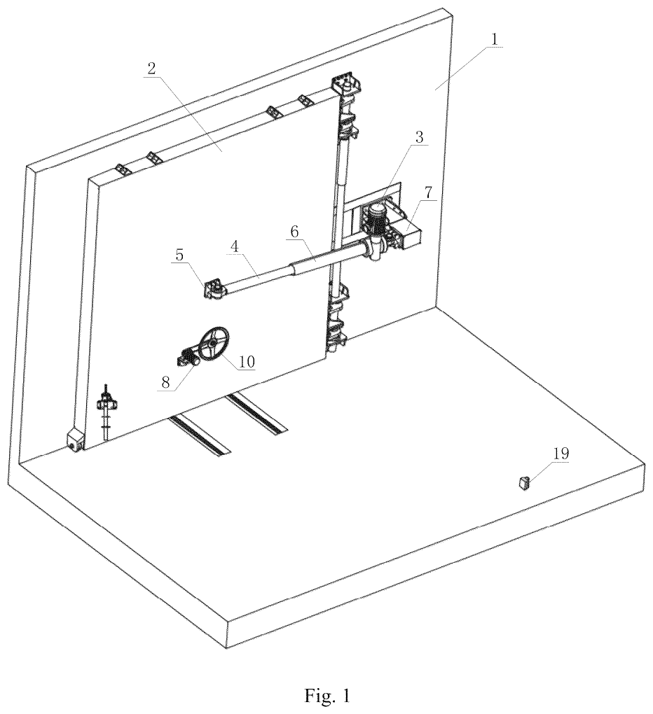

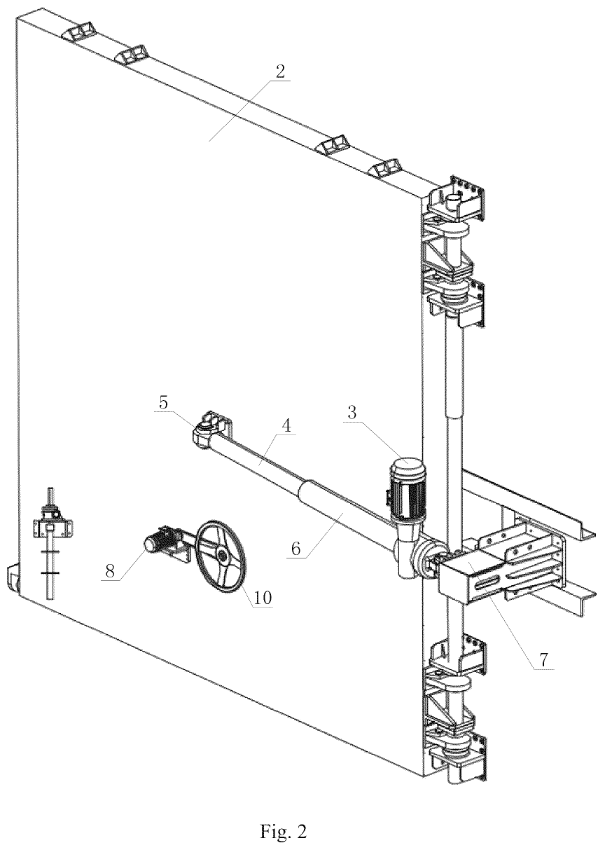

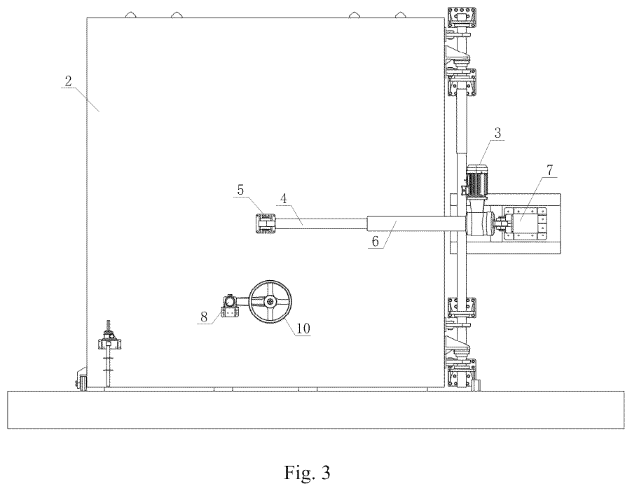

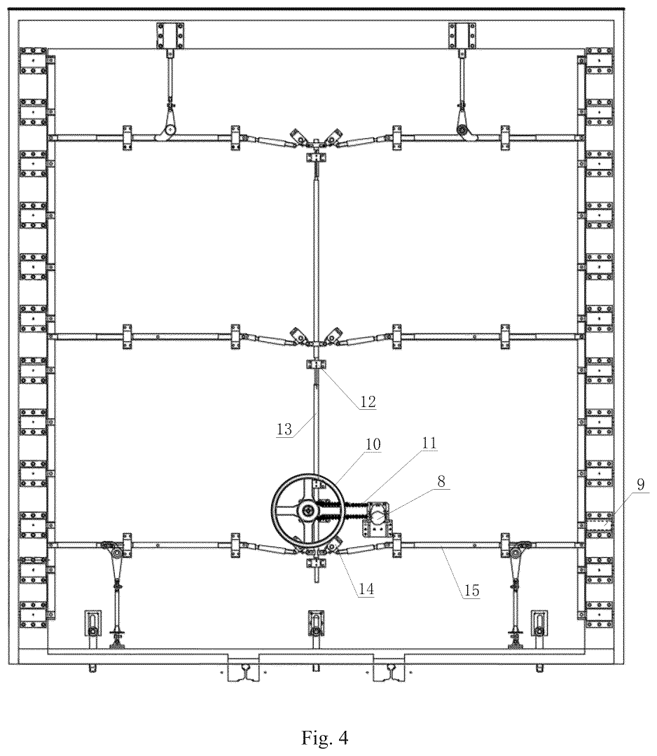

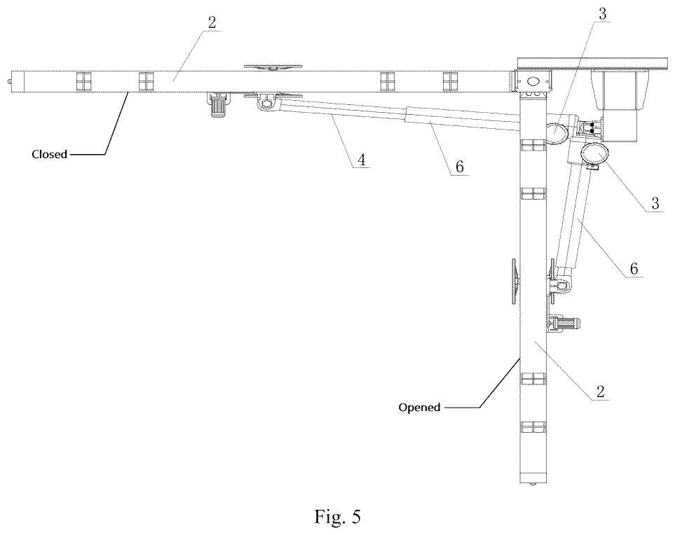

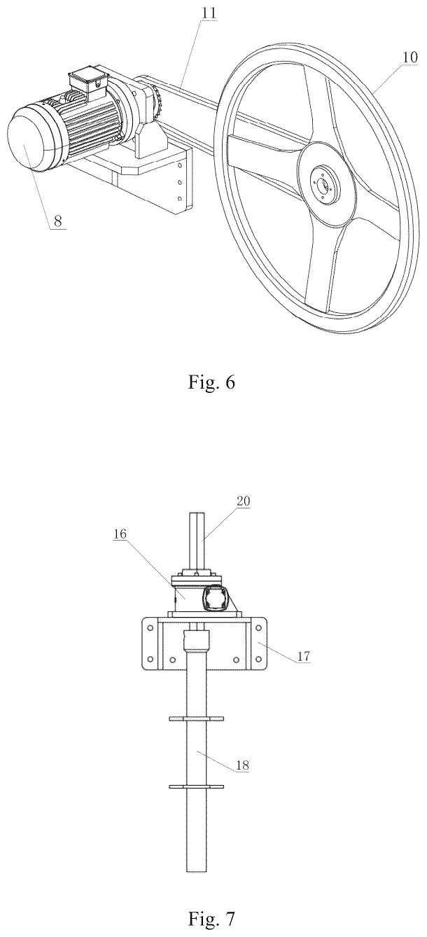

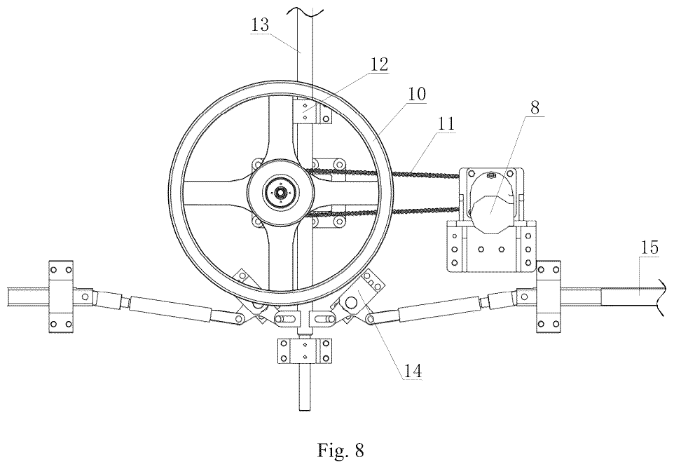

The blast door control system is not shown in FIGS. 1-8.

### REFERENCE SIGNS

1—mounting base; 2—door body; 3—drive motor module; 4—push rod; 5—door body mounting base; 6—opening and closing cylinder; 7—fixed base; 8—locking servo motor; 9—lock tongue; 10—handwheel; 11—gear transmission pair; 12—guide rod mounting seat; 13—guide rod; 14—connecting rod bracket; 15—connecting rod; 16—lifter; 17—lifter mounting base 17; 18—restriction rod; 19—restriction seat 19; 20—screw rod.

### DETAILED DESCRIPTION OF THE EMBODIMENTS

The present invention will be described in detail below with reference to the accompanying drawings and in conjunction with the embodiments. The various examples are provided by way of explanation of the present invention and are not intended to limit the present invention. Actually, it will be clear to those skilled in the art that modifications and variations can be made in the present invention without departing from the scope or spirit of the present invention. For example, a feature shown or described as a part of one embodiment may be used in another embodiment so as to create yet another embodiment. Therefore, it is expected that the present invention includes such modifications and variations that fall within the scope of the appended claims and their equivalents.

In the description of the present invention, the terms “longitudinal”, “lateral”, “upper”, “lower”, “front”, “rear”, “left”, “right”, “vertical”, “horizontal”, “top”, “bottom” and the like intend to indicate the orientation or position relationship based on that shown in the accompanying drawings, which is only for the convenience of describing the present invention and shall not mean that the present invention would be constructed and operated in a specific orientation, and therefore cannot be understood as limiting the present invention. The terms “connect (connected, connecting)” and “connection” presented in the present invention should be interpreted in a broad sense, for example, it may be a fixed connection or a detachable connection; it may be directly connected or indirectly connected through an intermediate component. For those skilled in the art, the specific meanings of the above terms can be understood in accordance with specific cases.

Please refer to FIGS. 1-8.

The present invention provides an electrically driven control system for a rotatable upright blast door. An opening and closing device of electric cylinder of rotatable upright door body has a simple structure, which reduces the complexity of maintenance and management. Compared with the hydraulic drive system, the opening and closing device of electric cylinder of rotatable upright door body does not need to regularly replace the hydraulic oil, to clean oil circuits and to repair hydraulic components, which reduces maintenance costs and workload, and also is a solution that meets environmental protection and modern management.

In the present invention, the electrically driven control system for the rotatable upright blast door comprises:
Part (I): a blast door for mounting onto the mounting base 1 (the mounting base 1 refers to the existing building of the subway system); wherein the blast door comprises a door frame and a door body 2 which is rotatable, upright, and is a side hung door, and the door frame is fixed to the mounting base 1 by pre-buried anchor bolts, and the door body 2 is mounted on the door frame through a hinge assembly. The hinge assembly is provided on one side of the door body 2, and a wheel assembly is provided on the other side of the door body 2 and at the bottom of the door body 2, for supporting the other side of the door body 2, thereby reducing the load-bearing of the door body 2 on the hinge assembly.
Part (II): an opening and closing device of electric cylinder of rotatable upright door body for implementing the electrical opening and closing of the door body 2. In prior art, the device for implementing the drive to open and close the door body is a hydraulic drive system. In the present invention, the device for implementing the drive to open and close the door body 2 is an electrical drive system with an electric cylinder structure. The opening and closing device of electric cylinder of rotatable upright door body includes a drive motor module 3 and a push rod 4 connected to the power output end of drive motor module 3. The opening and closing device of electric cylinder of rotatable upright door body is hinged relative to the mounting base 1 and the push rod 4 is hinged to the door body 2.

Specifically, the opening and closing device of electric cylinder of rotatable upright door body includes a door body mounting base 5 for fixing onto the door body 2, an opening and closing cylinder 6, a push rod 4 movably mounted on the opening and closing cylinder 6, a door body opening and closing servo motor for providing power which is provided on the opening and closing cylinder 6, a first manual rocker which is integrated on an opening and closing servo motor of the door body and is able to manually drive its motor output shaft to rotate, a first reducer connected to a power output end of the door body opening and closing servo motor for decelerating, and a fixed base 7 which is fixed relative to the mounting base 1, wherein the door body opening and closing servo motor and the first manual rocker are integrated as a whole and compose the drive motor module 3. The door body opening and closing servo motor includes the motor output shaft, on which a manual rocker gear is arranged for rotating synchronously, and the first manual rocker is intermeshed with the manual rocker gear through a gear set for manually driving the manual rocker gear to rotate. In the above structure, the electric cylinder is structurally composed of the opening and closing cylinder 6, the push rod 4 and the door body opening and closing servo motor. The push rod 4 fits with the opening and closing cylinder 6 and performs a telescopic movement within the opening and closing cylinder 6 under the drive of the door body opening and closing servo motor, and the telescopic movement can achieve the opening and closing of the door body.

The opening and closing cylinder 6 is structurally formed in an elongated cylindrical shape. A restriction rail is provided within the opening and closing cylinder 6. The push rod 4 can be mounted into interior of the opening and closing cylinder 6 through a linear bearing. A restriction groove structure that fits with the restriction rail can also be provided on the push rod 4, so that the push rod 4 can move linearly within the opening and closing cylinder 6 without any circumferential rotations. Push rod teeth are further provided on the push rod 4 (the push rod teeth can be racks, which are directly mounted on the push rod 4). The push rod teeth are arranged in a straight line along the axis of the push rod 4. The push rod 4 is slidably provided in the opening and closing cylinder 6. One end of the push rod 4 is positioned within the opening and closing cylinder 6, and the other end of the push rod 4 is positioned outside the opening and closing cylinder 6. It would enable that, when the push rod 4 is mounted to the interior of the opening and closing cylinder 6 and is sliding, the linear bearing, the restriction rail and the push rod teeth would not affect each other. For example, the linear bearing is provided at both ends of the push rod 4, and the push rod teeth and the restriction groove structure are provided in the middle portion of the push rod 4. Alternatively, the linear bearing is provided both at the front end and the middle portion of the push rod 4, and the push rod teeth and a restriction groove structure are provided at the rear end of the push rod 4. The first reducer specifically includes a gearwheel and a pinion. The pinion is connected to the power output end of the door body opening and closing servo motor. The gearwheel is as the power output end. The power output end of the first reducer is provided with a driving gear (the driving gear is coaxially arranged with the gearwheel, so as to rotate synchronously with the gearwheel). The driving gear is meshed with the push rod teeth. Further, the present invention may provide a housing mold, and the door body opening and closing servo motor and the first reducer are mounted on the housing mold in an integrated way. A manual rocker gear may be further provided inside the housing mold, and the manual rocker gear may be mounted onto the motor output shaft, or meshed with the pinion of the first reducer. A gear set may be provided on the first manual rocker, and the gear set is meshed with the manual rocker gear to achieve the manual control. The specific connection structure between the door body opening and closing servo motor and the first manual rocker is designed for achieving the power output of the door body opening and closing servo motor, meanwhile, the power output is achieved by the use of the first manual rocker. In addition, the first manual rocker may be easily removed from the gear set (similar to a tractor that is started by hand). In the present invention, a door body mounting base 5 is fixedly mounted on the door body 2. The door body mounting base 5 is a metal member. The door body mounting base 5 is a unitary structure, and the door body mounting base 5 is fixedly arranged on the door body 2. In the present invention, there is a fixed base 7 provided on the door frame. The fixed base 7 is a metal member. The metal component is a unitary structure. The metal member is fixedly arranged on the door frame of the blast door or is fixedly arranged on the mounting base 1. One end of the opening and closing cylinder 6 is hinged to the fixed base 7 through a rotating pin, and one end of the push rod 4 is hinged to the door body mounting base 5 through a rotating pin.

Further, there are a plurality of groups of the opening and closing device of electric cylinder of rotatable upright door body, and all opening and closing devices of electric cylinder of rotatable upright door body are arranged at intervals in the height direction.
Part (III): a blast door control system for implementing the operation control of the electrically driven control system. The blast door control system is a redundant control system. The blast door control system includes a main controller and a backup controller. Both the main controller and the backup controller may independently control the operation of the electrically driven control system, and when the main controller fails, the backup controller intervening the operation.

The blast door control system adopted by the present invention employs a redundant PLC system. When the main controller of the system fails, it will be automatically switched to the backup controller. If the overall system loses power, the main control room of the station will diagnose whether the communication of the blast door control system is abnormal, if so, and a trouble indication would be issued, and then arranging staffs to the blast door control room for processing failure. In case that the blast door control system is working but the water level sensor fails, the system can diagnose the water level sensor, and determine that the water level signal is abnormal, and then gives an alarm on the spot and upload the alarm to the main control system of the station. The blast door control system is mainly connected to the main control system of the station. The failure would be fed back to the main control system as long as the system failure happens (including the water level meter failure).
Part (IV): a manual-electric locking device for the door body provided on the door body 2. The manual-electric locking device for the door body includes a locking servo motor 8 and a drive train for the handwheel and the connecting rod. The drive train for the handwheel and the connecting rod is provided on the door body 2. A lock tongue 9 is provided at a movable end of the drive train for the handwheel and the connecting rod. The drive train for the handwheel and the connecting rod includes a handwheel 10, with which the locking servo motor 8 can be linked. The locking servo motor 8 is used to provide electric power to the drive train for the handwheel and the connecting rod, or the handwheel 10 is used to provide manual work to the drive train for the handwheel and the connecting rod.

Specifically, the manual-electric locking device for the door body is mounted on the front of the door body 2; the manual-electric locking device for the door body includes the handwheel 10, a gear transmission pair 11, a locking servo motor 8, the guide rod mounting seat 12, the guide rod 13, a connecting rod bracket 14, a connecting rod 15, a second reducer and a lock tongue 9; the handwheel 10 is connected to the input end of the second reducer; the driven gear of the gear transmission pair 11 is fixed on the handwheel 10; the driving gear of the gear transmission pair 11 is fixed on the output shaft of the locking servo motor 8; the guide rod 13 is fixedly connected to the output shaft of the second reducer; the guide rod 13 is slideable in the guide rod mounting seat 12; the connecting rod bracket 14 is connected to the guide rod 13; the connecting rod 15 is linked to the guide rod 13 through the connecting rod bracket 14; and the lock tongue 9 is provided at the end of the connecting rod 15. In the present invention, the second reducer and the locking servo motor 8 are integrated in a housing mold, thereby implementing the modularization of the assembly, thereby facilitating the installation.
Part (V): a door body guide and servo motor driven locking device for restricting and locking the opening of the door body 2 when the door body 2 is opened to an extreme position. The door body guide and servo motor driven locking device includes: a second manual rocker, a lifter 16, a restriction servo motor, a lifter mounting base 17, a restriction rod 18 and a restriction seat 19; the lifter 16 includes a lifter cylinder, in which a liftable screw rod 20 is provided; the power output end of the restriction servo motor is connected to the screw rod 20 through the third reducer for driving the screw rod 20 to rotate and lift in the lifter cylinder; the second manual rocker is integrated as a whole with the restriction servo motor; the restriction rod 18 is connected to the screw rod 20; the restriction seat 19 is fixed relative to the ground, and the restriction rod 18 is fitted with the restriction seat 19 by insertion. The combined structure of the restriction servo motor, the second manual rocker and the third reducer is similar to the structure of the drive motor module 3, that is, the restriction servo motor and the third reducer are integrated in a housing mold, and the second manual rocker realizes dual power output through the gear set and the restriction servo motor.
Part (VI): An emergency power supply (EPS) system, which is connected to each of electrical devices of the electrically driven control system for the rotatable upright blast door, and is used to provide backup power in the power-off state.

Further, in the present invention, there are three motor devices, namely, the door body opening and closing servo motor, the locking servo motor 8 and the restriction servo motor. In a preferred embodiment of the present invention, the door body opening and closing servo motor, the locking servo motor 8 and the restriction servo motor are all servo motors with brakes (that is, the brake is engaged after the servo motor is powered off to achieve self-locking of the servo motor). The innovation of the present invention is that the electric cylinder structure (which can be understood as the door body opening and closing servo motor, the locking servo motor 8 and the restriction servo motor) is used as the power system of each of implementing members. Compared with the hydraulic drive system, it is more accurate and reliable in electrical control, which can ensure that the blast door is quickly and accurately closed when needed. In addition, the electric cylinder drive system does not have the risk of hydraulic oil leakage, thereby reducing the potential risk to the environment and equipment.

The present invention provides an electrically driven control system for a rotatable upright blast door, specifically including a door body guide and servo motor driven locking device, a opening and closing device of electric cylinder of rotatable upright door body and a blast door control system (remote monitoring system). The opening and closing device of electric cylinder of rotatable upright door body can automatically open and close the blast door according to the instructions issued by the blast door control system. The manual-electric locking device for the door body can be opened, closed and locked manually or automatically (the “manually” means the staff manually opens or closes the door body, and the “automatically” means the servo motor is employed to drive the electric opening or closing). The door body guide and servo motor driven locking device are used to fix the position of the door body 2 when it is operated to the extreme position. The blast door control system can monitor the status of water level in the operation range of the blast door, the operating status of each device in the entire system, and can send a blast door opening or closing request to the main control room according to the actual status, and perform relevant control on the entire system after receiving the instructions from the main control room. The present invention has advantages of the simple structure, low cost, small layout space, and is suitable for the environment of subway line sections, and reduces the maintenance and management complexity. All devices can be operated manually or automatically, and have remote monitoring function.

The present invention adopts a method combining the overall design and multiple experimental researches, so as to study and develop an electric cylinder structure suitable for the blast doors used in the subway. In addition, the mechanical design and electrical design of the opening and closing device for the electric cylinder of the rotatable upright door body are carried out according to design requirements, water head and other indicators, as well as the opening and closing force of the blast door is calculated. On the premise of meeting the requirements of civil air defense and flood prevention, it is necessary to carry out non-standard design for the existing opening and closing mechanism and support mechanism to achieve functional requirements. The optimization scheme is adopted to implement the trial production and various performance tests of the original hydraulic drive system, so as to test the opening and closing performance and flood prevention performance of the blast door, as well as the usability, safety and reliability of the entire system.

It is described above that the structural design of an electrically driven control system for a rotatable upright blast door is provided by the present invention. Through the above description of the structure, it can be seen that the electrically driven control system provided by the present invention has the following technical advantages:
1. In the opening and closing device of electric cylinder of rotatable upright door body, the power device adopts a structure of the opening and closing cylinder 6 and the door body opening and closing servo motor. The servo motor (the door body opening and closing servo motor) is mounted on the opening and closing cylinder 6 as a driver, and the operation of the blast door control system adopts a closed-loop control technology to achieve precise control of the entire opening and closing process of the blast door, making the operation of the blast door more intelligent.
2. The entire opening and closing process of the opening and closing device of electric cylinder of rotatable upright door body is equipped with an automatic power-off braking function (the door body opening and closing servo motor adopts a servo motor with a brake function), which ensures that the position of the blast door is self-locking and increases safety.
3. The speed of the entire opening and closing process of the opening and closing device of electric cylinder of rotatable upright door body is adjustable (the opening and closing speed of the electric cylinder structure is regulated by controlling the operating speed of the door body opening and closing servo motor), with better performance and meeting the needs of different working conditions.
4. The structure of the opening and closing device of electric cylinder of rotatable upright door body is simpler (compared with the hydraulic drive system), and the opening and closing device of electric cylinder of rotatable upright door body also reduces the complexity of maintenance and management. Compared with the hydraulic drive system, the opening and closing device of electric cylinder of rotatable upright door body does not need to regularly replace the hydraulic oil, to clean oil circuits and to repair hydraulic components, which reduces maintenance costs and workload. Meanwhile, the opening and closing device of electric cylinder of rotatable upright door body does not have the risk of hydraulic oil leakage, which would not bring the pollution to environment.
5. The EPS system is adopted to ensure that the blast door can be opened or closed smoothly in the event of system power failure. The present invention provides an electrically driven control system for a rotatable upright blast door, including: a blast door for mounting onto the mounting base 1, the blast door comprising a door body 2 which is rotatable, upright, and is a side hung door; an opening and closing device of electric cylinder of rotatable upright door body for implementing the electrical opening and closing of the door body 2, wherein, the opening and closing device of electric cylinder of rotatable upright door body includes a drive motor module 3 and a push rod 4 connected to the power output end of the drive motor module 3, and the opening and closing device of electric cylinder of rotatable upright door body is hinged relative to the mounting base 1, and the push rod 4 is hinged to the door body 2; a blast door control system for implementing the operation control of the electrically driven control system, wherein, the blast door control system is a redundant control system, and the blast door control system includes a main controller and a backup controller, and both the main controller and the backup controller may independently control the operation of the electrically driven control system, and when the main controller fails, the backup controller intervenes the operation.

In the present invention, the process of the closing operation for the blast door is as follows:
1. The withdrawn action of restriction rod is carried out, which stops when it is fully withdrawn;
2. The electric cylinder structure extends, the action of closing the door is carried out and stops when the door leaf is fully closed;
3. The locking action of the manual-electric locking device for the door body is carried out, which stops when it is fully locked. The process of the closing door ends.

In the present invention, the process of the opening operation for the blast door is as follows:
1. The unlocking action of the manual-electric locking device for the door body is carried out, which stops when it is fully unlocked.
2. The retracting action of the electric cylinder structure, the action of opening the door is carried out and stops when the door leaf is fully opened;
3. The entering action of restriction rod is carried out, which stops when it is fully entered; The process of the opening door ends.

In the present invention, the blast door control room is responsible for monitoring the operating status of the blast door and its accessory equipment. The operating status of this system includes the following parameters: 1. Door leaf: fully open position, fully closed position; 2. Restriction rod: fully entered, fully withdrawn; 3. Locking device: fully locked, fully unlocked.

Based on the above status, the present invention needs to monitor: 1. the status of the action of opening and closing the blast door; 2. the status of entering or withdrawn the restriction rod; 3. the locked or unlocked status of the locking device; 4. the control mode of the blast door; 5. the action of system equipment power supply; 6. water level gauge: first, second, and third level water level monitoring; 7. the status of system fault, etc.

The technical requirements for each structure of the system of the present invention are as follows:
1. The opening and closing device of electric cylinder of rotatable upright door body is required to be able to close against water under a 3-meters water-head of the blast door;
2. The pressure load of two-way water-head is required for 40 meters;
3. External dimensions: 6000 mm×6500 mm (width×height), meeting the requirements of subway vehicle equipment limits;
4. The sealing performance meets the requirements of quality inspection and construction acceptance;
5. All actions are automatically controlled, basically;
6. Automatic water level monitoring and alarm are realized;
7. All actions are required to be manually operated when the power is off;
8. The anti-corrosion performance meets the requirements of blast doors for subway;
9. Meeting the process requirements of large-size component machining, transportation, and installation.

For the present invention, the following specific problems need to be considered during the overall design of the equipment:
1. Improving the protection performance: ensure that the oversized blast door with electrically driven function can maintain its structural integrity and airtightness when facing various extreme environments or potential threats, and effectively prevent the invasion of external harmful factors;
2. Enhancing stability and reliability: improving the stability and reliability of the blast door by optimizing the design and material selection, reducing the possibility of failure, and extending the service life;
3. Realizing intelligent control: by introducing advanced sensors, blast door control systems and communication technologies, realizing the automation and intelligent control of the door, and improving the convenience and safety of use.

The opening and closing device of electric cylinder of rotatable upright door body used in the subway cross-river tunnel involved in the present application can automatically close in the presence of water, while meeting the requirements of civil defense and flood prevention functions. Moreover, after the successful development of the opening and closing device of electric cylinder of rotatable upright door body, the present invention can also reduce equipment and construction costs, reduce pipeline construction, reduce operating and maintenance costs, and optimize the subway environment.

The purpose of the present invention is to improve the deficiencies in the prior art and provide a control system for rotatable upright blast doors with reasonable design, simple structure, small space occupation, safety and reliability. The system is operated in two control modes: manual control and servo motor drive, and can realize intelligent remote control. The control system for the rotatable upright blast door provided by the present invention includes: an mounting base 1 (civil engineering supporting facilities), a blast door, a door body guide and servo motor driven locking device, a manual-electric locking device for the door body, a opening and closing device of electric cylinder of rotatable upright door body, and a blast door control system. The blast door control system is respectively connected to the door body guide and servo motor driven locking device, the opening and closing device of electric cylinder of rotatable upright door body, and the manual-electric locking device for the door body (for implementing the opening and closing control of the above-mentioned devices).

The opening and closing device of electric cylinder of rotatable upright door body is mounted on the back of the door body 2 of the blast door, including a fixed base 7 (fixed on the mounting base 1 by pre-buried anchor bolts or other structures), a first rotating pin, a second rotating pin, and an electric cylinder assembly. The electric cylinder assembly includes an electric cylinder (opening and closing cylinder 6), a push rod 4, and a drive motor module 3. The electric cylinder (opening and closing cylinder body 6) is fixed on the mounting bracket of the fixed base 7 in a hinged way through a first rotating pin. One end of the electric cylinder (opening and closing cylinder 6) is hinged on the first rotating pin, and the other end is connected to the push rod 4. The other end of the push rod 4 is connected to the door body mounting base 5 through a second rotating pin. In practical applications, a plurality of groups of the opening and closing device of electric cylinder of rotatable upright door body may be provided according to the opening and closing resistance of the door body 2, and the plurality of groups of the opening and closing device of electric cylinder of rotatable upright door body are arranged horizontally on the top and bottom of the door body 2. In the embodiment of the present invention, only one group is provided. The device has a simple structure and compact arrangement, which meets the installation requirements for a small space. The optimal fixing point is calculated according to the actual opening resistance to meet the requirements of rapid opening and closing of the blast door.

The manual-electric locking device for the door body is mounted on the front of the door body of the blast door, including a handwheel 10, a gear transmission pair 11, a locking servo motor 8, a guide rod mounting seat 12, a guide rod 13, a connecting rod bracket 14, a connecting rod 15, and a lock tongue 9. The handwheel 10 is connected to the input end of the second reducer, and the driven gear of the gear transmission pair 11 is fixed on the output shaft of the handwheel 10. The driving gear of the gear transmission pair 11 is fixed on the output shaft of the locking servo motor 8. The guide rod 13 is fixed to the output shaft of the second reducer, and the guide rod 13 can slide up and down in the guide rod mounting seat 12. In the present invention, when the manual-electric locking device for the door body receives the locking signal from the remote monitoring system, the locking servo motor 8 drives the driving gear of the gear transmission pair 11, and drives the second reducer input end after being transmitted by the driven gear, thereby driving the guide rod 13 to move downward. At this time, the connecting rod bracket 14 moves downward together with the guide rod 13, and the connecting rod 15 slides up and down in the guide rod mounting seat 12 to drive the connecting rod 15 to move downward, so that the lock tongue 9 finally reaches the locking position and completes the locking of the door body 2. When the device receives the unlocking signal from the remote monitoring system, the movement of the device is opposite to the above process. The device can be switched between manual mode and automatic mode. In the manual mode, the brake of the locking servo motor 8 is unlocked (the present invention may provide a backup power supply for powering the locking servo motor 8 to drive the brake unlocking in the event of a power outage), and the staff directly turns the handwheel 10 to operate. In the automatic mode, the system drives the locking servo motor 8 to complete corresponding operations.

The blast door control system consists of two independent control systems, which are respectively provided within the blast door sections of the left and right tunnels of the station. The blast door control room is responsible for monitoring the operating status of the blast door and its accessory equipment. The water level signal sent by the water level sensor is compared and confirmed, and the corresponding operation request is uploaded to the main control system of the station control room (or the main control room of the station) according to the confirmation result. When it is necessary to close or open the door, the staff sends the closing or opening signal through the blast door control room. Only after the permission of the main control room of the station, the closing or opening command could be issued manually. The blast door control room controls the corresponding devices to complete the opening or closing command. The water level sensor is provided in the lowest section water pump room of each protective section tunnel. Its automatic alarm limit and water level rise limit can be set according to relevant standards or actual conditions. When the water level or water level rise speed exceeds the set limit, the blast door control room sends an alarm signal and a closing request to the main control room of the station. The main control room of the station decides the corresponding operation and issues instructions. The blast door control room performs the corresponding operation after receiving the instructions from the main control room.

The door body guide and servo motor driven locking device, the opening and closing device of electric cylinder of rotatable upright door body, and the manual-electric locking device for the door body are connected to the remote monitoring system. The door body 2 is equipped with a position sensor or a travel switch for detecting the position of the door body 2. The control of the door body guide and servo motor driven locking device can be divided into two modes: the manual mode and the automatic mode. In the manual mode, the restriction servo motor brake is unlocked, and the opening and closing or locking of the restriction of the door body 2 is completely operated manually.

When the electrically driven control system of the present invention receives the instruction of opening the blast door and needs to open the door automatically, the various systems work together as follows: the manual-electric locking device for the door body performs the unlocking operation. Then the opening and closing device of electric cylinder of rotatable upright door body performs the operation of opening the door, that is, the electric cylinder structure is pulled back to drive the door body 2 to open the door until the door body 2 is opened to a specified position. Finally, the door body guide and servo motor driven locking device carries out the locking of the door body 2, that is, when the door body 2 is opened to a position close to the limit, the guide slider guides and decelerates the door body 2, and the door body 2 stops when it reaches the limit position, and the restriction servo motor drives the restriction rod 18 to complete the locking of the door body 2. Similarly, when the electrically driven control system receives the instruction of closing the blast door and needs to close the door automatically, its collaborative working sequence is opposite to the above actions, that is, firstly the door body guide and servo motor driven locking device carries out the unlocking, then the opening and closing device of electric cylinder of rotatable upright door body closes the door body 2 to the limit position, and finally the manual-electric locking device for the door body completes the locking of the door body 2.

For the electrically driven control system for the rotatable upright blast door provided by the present invention, its specific structure is as follows: including the door body guide and servo motor driven locking device, the opening and closing device of electric cylinder of rotatable upright door body, the manual-electric locking device for the door body and the remote monitoring system (the blast door control system). The blast door control system is respectively connected to the door body guide and servo motor driven locking device, the opening and closing device of electric cylinder of rotatable upright door body, and the manual-electric locking device for the door body (the connection of the control is implemented via cables). The door body guiding and servo motor driven locking device is composed of a restriction rod 18, a locking servo motor 8 and a restriction seat 19 and so on, wherein the restriction rod 18 is mounted at the bottom of the cantilever end of the door body 2 of the blast door. After the door body 2 is opened and reaches the limit position, the restriction rod 18 can be lowered (the action can be completed manually, similar to the latch structure; it can also be completed electrically, that is, driven by the restriction servo motor, and the instruction of completing the telescopic action is received by the restriction servo motor, and the telescopic action is performed) and inserted into the restriction seat 19, thereby implementing the locking of the door body 2.

The opening and closing device of electric cylinder of rotatable upright door body (except the restriction seat 19) is mounted on the back of the blast door, including the lifter mounting base 17 and the restriction rod 18. The restriction rod 18 can be provided in the mounting base 17 and is liftable thereon. The restriction servo motor is mounted on the lifter mounting base 17, and a screw rod 20 is arranged on the lifter mounting base 17. The restriction servo motor drives the screw rod 20 to rotate through the third reducer. The screw rod 20 and the lifter mounting base 17 can be used together to move up and down. The screw rod 20 is connected to the restriction rod 18 through a rotatable joint, so that the restriction rod 18 can be lifted and lowered with the action of the screw rod 20. When the door body 2 is opened to the limit position, the remote monitoring system locks the door body 2 according to the signal of the door body position sensors. At this time, the restriction servo motor drives the restriction rod 18 to descend and then plug in and fitted with the restriction seat 19 to complete the locking of the door body 2.

In the present invention, the manual-electric locking device for the door body includes a connecting rod 15 and a lock tongue 9 and other structures. One connecting rod 15 and one lock tongue 9 forms a group of locking units. Multiple groups of locking units are arranged on the back of the door body 2 at left and right sides according to the actual force or the locking units are increased or reduced according to actual needs. All locking units are connected to the connecting rod bracket 14 through the guide rod mounting seat 12. In addition, the present invention is equipped with a position sensor or a travel switch in the door body 2 for detecting the position of the door body 2.

The electric cylinder assembly has a structure as follows, including: a door body mounting base 5, a push rod 4, an opening and closing cylinder 6, a door body opening and closing servo motor, a first manual rocker, a first reducer, a gear set, and a fixed base 7. The above-mentioned gear set is used to realize the connection between the first manual rocker and the motor shaft of the door body opening and closing servo motor. When the first manual rocker is manually cranked, the motor shaft of the door body opening and closing servo motor can be driven to rotate through the gear set. Wherein, the door body opening and closing servo motor is integrated with the first manual rocker as a whole. The door body opening and closing servo motor has a motor output shaft. A manual rocker gear that rotates synchronously with the motor output shaft can be provided on the motor output shaft. The first manual rocker is connected to the manual rocker gear (connected by gear meshing or key connection). In this way, in the power-off state, the motor output shaft of the door body opening and closing servo motor can be driven to rotate by cranking the first manual rocker, thereby completing the manual opening and closing of the door.

The structure of the door body guide and servo motor driven locking device is as follows, including a second manual rocker, a lifter 16, a restriction servo motor, a lifter mounting base 17, a restriction rod 18 and a restriction seat 19. The restriction rod 18 is mounted on the lifter mounting base 17 through a screw rod 20 and is retractable. When the door body 2 opens to the limit position, it is restricted by the restriction seat 19 (the restriction seat 19 can be a structure that protrudes, or is flush, or sinks with respect to the ground, and preferably protrudes relative to the ground, so that when the door body 2 is opened, it can be abutted against the door body 2 to achieve the limit of the opening of the door body 2). The restriction servo motor drives the screw rod 20 to descend, and then the screw rod 20 drives the restriction rod 18 to descend and insert into the restriction seat 19 up to the bottom and the restriction operation is completed.

The main innovations of the present invention are as follows:
1) High-precision positioning and fast response: the electric cylinder structure adopts advanced servo control system and driver, which can make the opening and closing device of electric cylinder of rotatable upright door body have high-precision positioning and fast response speed, ensuring that the blast door can be quickly closed in an emergency.
2) Selecting high-efficiency motors and optimized transmission systems to improve energy conversion efficiency, reducing energy consumption, and providing sufficient driving force and torque.
3) Modular design: the opening and closing device of electric cylinder of rotatable upright door body is divided into multiple independent modules for easy installation, debugging and maintenance. The connection between modules is simple and reliable, which improves the reliability and maintainability of the system. Easy to maintain: the opening and closing device of electric cylinder of rotatable upright door body has a simple structure and no complex components such as hydraulic oil circuits, which reduces the difficulty and cost of maintenance. At the same time, standardized interfaces and accessories are used to facilitate maintenance and replacement.
4) Zero emission and low noise: the opening and closing device of electric cylinder of rotatable upright door body uses electricity as the power source, without the use of hydraulic oil and other media, achieving zero emission and low noise operation, in line with environmental protection requirements. The selection of high-efficiency motors and transmission systems reduces energy consumption and improves energy utilization efficiency.

Compared with the prior art, the present invention has the following advantages:
1. The opening and closing drive of the door body 2 is driven by an electric cylinder structure, which has a small layout space and a large opening and closing torque, and is suitable for the usage and layout requirements of the blast door of the subway civil air defense;
2. The opening and closing device of electric cylinder of rotatable upright door body has a simple structure, which reduces the complexity of maintenance and management. Compared with the hydraulic drive system, the opening and closing device of electric cylinder of rotatable upright door body does not need to regularly replace the hydraulic oil, to clean oil circuits and to repair hydraulic components, which reduces maintenance costs and workload, and also is a solution that meets environmental protection and modern management;
3. Each device of the system is driven by a servo motor (such as a door body opening and closing servo motor, a locking servo motor, a restriction servo motor, etc.). When the power is off in an emergency, the servo motor automatically releases the brake. At this time, the relevant operations can be performed manually, and the system will not generate additional opening and closing resistance.

The above is only a preferred embodiment of the present invention and is not intended to limit the present invention. For those skilled in the art, the present invention can have various changes and variations. Any modifications, equivalent substitutions, improvements, etc. made within the spirit and principles of the present invention should be included in the protection scope of the present invention.

What is claimed is:

1. An electrically driven control system for a rotatable upright blast door, characterized in that it comprises:
a blast door for mounting onto a mounting base, the blast door comprising a door body which is rotatable, upright, and is a side hung door;
an opening and closing device of electric cylinder of rotatable upright door body for implementing an electrical opening and closing of the door body, the opening and closing device of electric cylinder of rotatable upright door body including a drive motor module and a push rod coupled to a power output end of the drive motor module; the opening and closing device of electric cylinder of rotatable upright door body being hinged relative to the mounting base and the push rod being hinged to the door body;
a blast door control system for implementing an operation of the electrically driven control system, wherein, the blast door control system is a redundant control system, and the blast door control system includes a main controller and a backup controller, and both the main controller and the backup controller can independently control the operation of the electrically driven control system, and when the main controller fails, the backup controller intervenes the operation;
the opening and closing device of electric cylinder of rotatable upright door body includes a door body mounting base for fixing onto the door body, an opening and closing cylinder, the push rod movably mounted on the opening and closing cylinder, a door body opening and closing servo motor for providing power which is provided on the opening and closing cylinder, a first manual rocker which is integrated on the opening and closing servo motor of the door body and is able to manually drive its motor output shaft to rotate, a first reducer connected to a power output end of the door body opening and closing servo motor for decelerating, and a fixed base which is fixed relative to the mounting base;
the door body opening and closing servo motor and the first manual rocker are integrated as a whole and compose the drive motor module;
the door body opening and closing servo motor includes the motor output shaft, on which a manual rocker gear is arranged for rotating synchronously, and the first manual rocker is intermeshed with the manual rocker gear through a gear set for manually driving the manual rocker gear to rotate;
push rod teeth are provided on the push rod, the push rod teeth are arranged in a straight line along axis of the push rod, and the push rod is slidably provided in the opening and closing cylinder, and one end of the push rod is positioned within the opening and closing cylinder, and the other end of the push rod is positioned outside the opening and closing cylinder, and a power output end of the first reducer is provided with a driving gear, and the driving gear is meshed with the push rod teeth;
a manual-electric locking device for the door body provided on the door body;
the manual-electric locking device for the door body includes a locking servo motor and a drive train for the handwheel and the connecting rod, and the drive train for the handwheel and the connecting rod is provided on the door body, and a lock tongue is provided at a movable end of the drive train for the handwheel and the connecting rod;
and the drive train for the handwheel and the connecting rod includes a handwheel, with which the locking servo motor can be coupled, and the locking servo motor is used to provide electric power to the drive train for the handwheel and the connecting rod, or the handwheel is used to provide manual work to the drive train for the handwheel and the connecting rod;
the manual-electric locking device for the door body is mounted on front of the door body;
and the manual-electric locking device for the door body includes the handwheel, a gear transmission pair, the locking servo motor, a guide rod mounting seat, a guide rod, a connecting rod bracket, a connecting rod, a second reducer and the lock tongue, and the handwheel is connected to an input end of the second reducer; a driven gear of the gear transmission pair is fixed on the handwheel; a driving gear of the gear transmission pair is fixed on an output shaft of the locking servo motor;
the guide rod is fixedly connected to the output shaft of the second reducer; the guide rod is slideable in the guide rod mounting seat; the connecting rod bracket is connected to the guide rod; the connecting rod is linked to the guide rod through the connecting rod bracket; and the lock tongue is provided at end of the connecting rod.

2. The electrically driven control system for the rotatable upright blast door according to claim 1, characterized in that,
the door body mounting base is a metal member, and the door body mounting base is a unitary structure, and the door body mounting base is fixedly arranged on the door body;
the fixed base is a metal member, and the metal member is a unitary structure, and the metal member is fixedly arranged on a door frame of the blast door or is fixedly arranged on the mounting base;
one end of the opening and closing cylinder is hinged to the fixed base through a rotating pin, and one end of the push rod is hinged to the door body mounting base through a rotating pin.

3. The electrically driven control system for the rotatable upright blast door according to claim 2, characterized in that,
there are a plurality of groups of the opening and closing device of electric cylinder of rotatable upright door body, and all opening and closing devices of electric cylinder of rotatable upright door body are arranged at intervals in the height direction.

4. The electrically driven control system for the rotatable upright blast door according to claim 1, characterized in that,
a door body guide and servo motor driven locking device is further included, which is used for restricting and locking the opening of the door body when the door body is opened to an extreme position.

5. The electrically driven control system for the rotatable upright blast door according to claim 4, characterized in that,
the door body guide and servo motor driven locking device includes:
a second manual rocker, a lifter, a restriction servo motor, a lifter mounting base, a restriction rod and a restriction seat;
the lifter includes a lifter cylinder, in which a liftable screw rod is provided; a power output end of the restriction servo motor is connected to the liftable screw rod through a third reducer for driving the liftable screw rod to rotate and lift in the lifter cylinder; the second manual rocker is integrated as a whole with the restriction servo motor; the restriction rod is connected to the liftable screw rod; the restriction seat is fixed relative to the ground, and the restriction rod is fitted with the restriction seat by insertion.

6. The electrically driven control system for the rotatable upright blast door according to claim 5, characterized in that,
the door body opening and closing servo motor, the locking servo motor and the restriction servo motor are all servo motors with brakes;
an emergency power supply system is further included, which is connected to each of electrical devices of the electrically driven control system, and is used to provide backup power in the power-off state.
